(19) United States
(12) Patent Application Publication
(10) Pub. No.: US 2019/0112113 A1
(43) Pub. Date: Apr. 18, 2019

(54) DRUG DELIVERY AND PATIENT REMINDER SYSTEM

(71) Applicant: Lane Samata, Chicago, IL (US)

(72) Inventor: Lane Samata, Chicago, IL (US)

(21) Appl. No.: 15/786,443

(22) Filed: Oct. 17, 2017

(51) Int. Cl. B65D 50/06; B65D 50/04; A61J 1/03

(52) U.S. Cl. CPC B65D 50/068; A61J 1/1437; A61J 1/03; B65D 50/04

(57) ABSTRACT

A drug delivery and patient reminder system is disclosed. The system includes an upper vessel adapted to attach to a lower vessel or existing medicine bottle. The upper vessel is closed with a cap and provides a separate compartment for placing a specified quantity of a medication, for example, one week's worth of medication. The remainder of the medication may be stored in the lower vessel compartment. The upper vessel may be reversible to allow a larger joint compartment to be formed. In this mode, the container may be turned upside down and a level indicator indicates when a certain quantity of medication remains, such as one week's worth of medication. A flanged cap provides a base of support and optional dispensing cup.

### BACKGROUND OF THE INVENTION

### Field of the Invention

The present invention relates to drug delivery and patient reminder systems, and more particularly, to a container having dual compartments and a reminder system.

### Background

Various drug delivery and patient reminder systems, such as medicine containers and medication dispensing and reminding systems have been proposed. However, an economical, practical system that optionally makes use of existing containers is lacking.

For example, U.S. Pat. No. 7,269,476 issued to Ratnakar, discloses a medicine dispensing system which automatically dispenses a dose. This system requires electronics and specialized containers. Thus, existing containers can be used. Furthermore, it fails to provide a practical and economical way to remind a patient when the medication is running low.

U.S. Published Patent Application No. 2007/0016443 discloses a medication compliance system. This system requires patient monitoring, and fails to provide practical and economical ways for a patient to use an existing medicine container and indicate when medication is running low so that the patient may reorder or refill a medication prescription.

U.S. Pat. No. 7,240,795, issue to Lee, discloses a medicine container having multiple parallel compartments and a rotatable lid having a hole which can be aligned with various compartments. Such an arrangement in which compartments are parallel does not provide an effective visual indication of when a medication is running low.

While various medicine dispensers and reminders have been proposed, there remains a need for a drug delivery and reminder system which is economical and provides an effective visual indication of when the medicine is running low, among other features and advantages.

### SUMMARY

The present invention is a drug delivery and patient reminder system. The system includes an upper vessel which interfaces with a lower vessel. The lower vessel is optionally a conventional medicine bottle with a connection interface, such as threading. The upper vessel includes a connection component such as threading to interface with the lower vessel.

The upper vessel further includes a lower wall which separates a lower compartment in the medicine bottle from an upper compartment in the upper vessel. Thus, a patient can place a predetermined amount of a medication, such as one week's worth of pills, in the upper compartment, and store the remainder of the medication in the lower compartment. When the only remaining medication is in the upper compartment, the patient will know that it may be time to order or refill a prescription.

Optionally, the upper vessel includes a connection component at its top end which ideally identical to the connection component at the lower end. Thus, the upper vessel can be turned upside down in another mode of use, and interfaced with the lower vessel. In this fashion, a larger joint compartment is created.

The upper vessel further includes a cap which interfaces with either end of the upper vessel. In the mode in which the larger joint compartment is formed, the entire container may be turned upside down. Ideally, the cap includes a flanged out portion which forms a wide base of support for the container. Ideally, the flanged out perimeter portion of the cap is wider than the side structure of the upper vessel.

In this upside down mode, a level indicator is optionally provided. The level indicator ideally can be placed in any of a plurality of level indication positions. Thus, the level indicator can be used to show when a predetermined amount of medication remains in the container, such as one week's worth of medication. When the level of medication reaches the indicator, the patient will know that new medication should be ordered.

In certain embodiments, the cap may include a concave cup-shaped receptacle on its top side to hold a dosage of medication.

Still other objects and advantages of the present invention will become readily apparent to those skilled in the art from the following detailed description, wherein it is shown and described only the preferred embodiments of the invention, simply by way of illustration of the best mode contemplated of carrying out the invention. As will be realized, the invention is capable of other and different embodiments and its several details are capable of modifications in various obvious respects, without departing from the invention. Accordingly, the drawings, wherein like reference numerals represent like features, and description are to be regarded as illustrative in nature and not as restrictive.

### BRIEF DESCRIPTION OF THE DRAWINGS

FIG. 1 illustrates a perspective view of the drug delivery and reminder system in accordance with one embodiment of the present invention.

FIG. 2 illustrates a perspective view of the drug delivery and reminder system in another mode of use in accordance with one embodiment of the present invention.

FIG. 3 illustrates an exploded view of the drug delivery and reminder system in accordance with one embodiment of the present invention.

FIG. 4 illustrates an exploded view of the drug delivery and reminder system in another mode in accordance with one embodiment of the present invention.

FIG. 5 illustrates a perspective view of the drug delivery and reminder system in another mode in accordance with one embodiment of the present invention.

FIG. 6 illustrates a perspective view of the drug delivery and reminder system in another mode in accordance with one embodiment of the present invention.

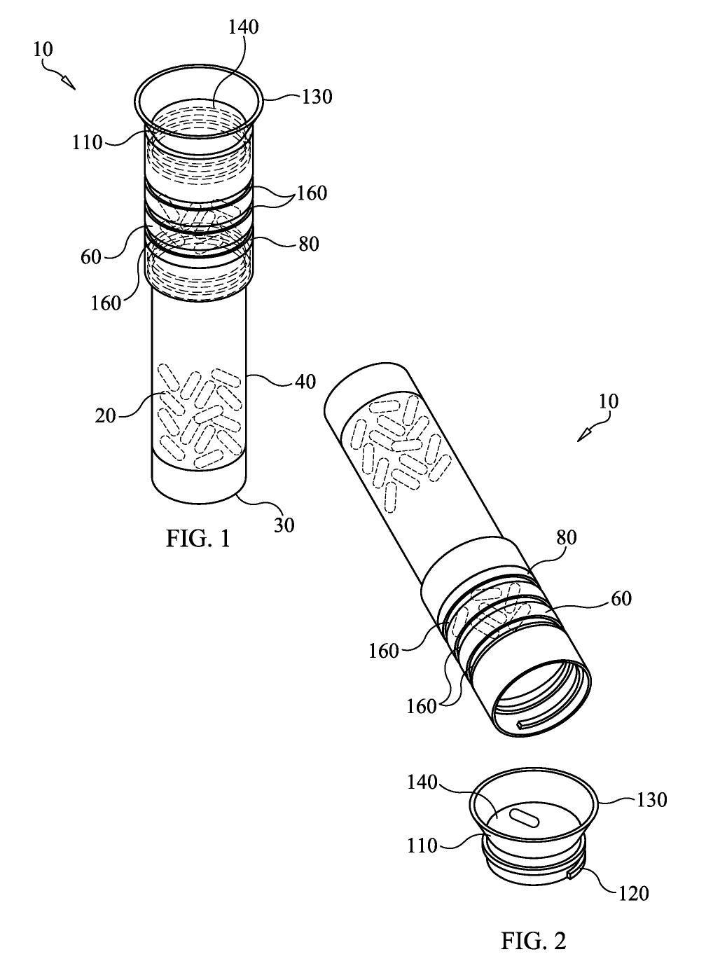

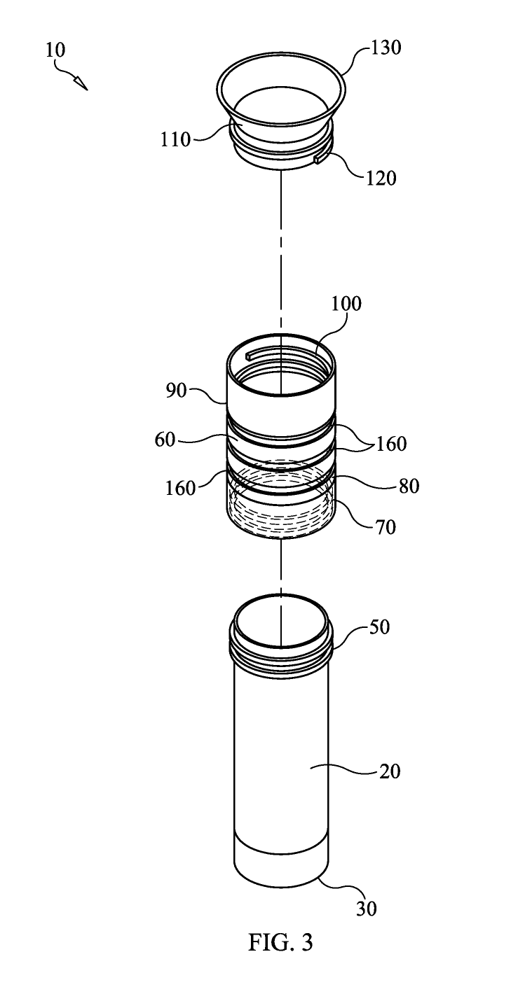

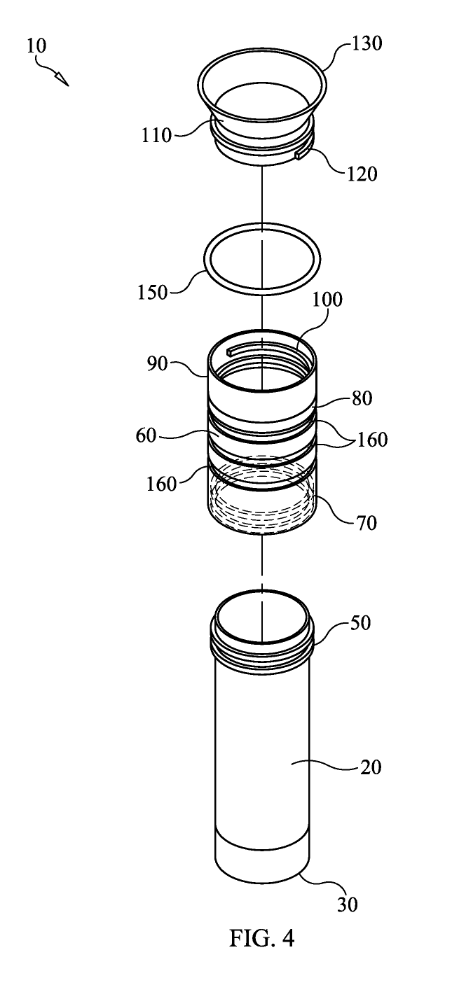

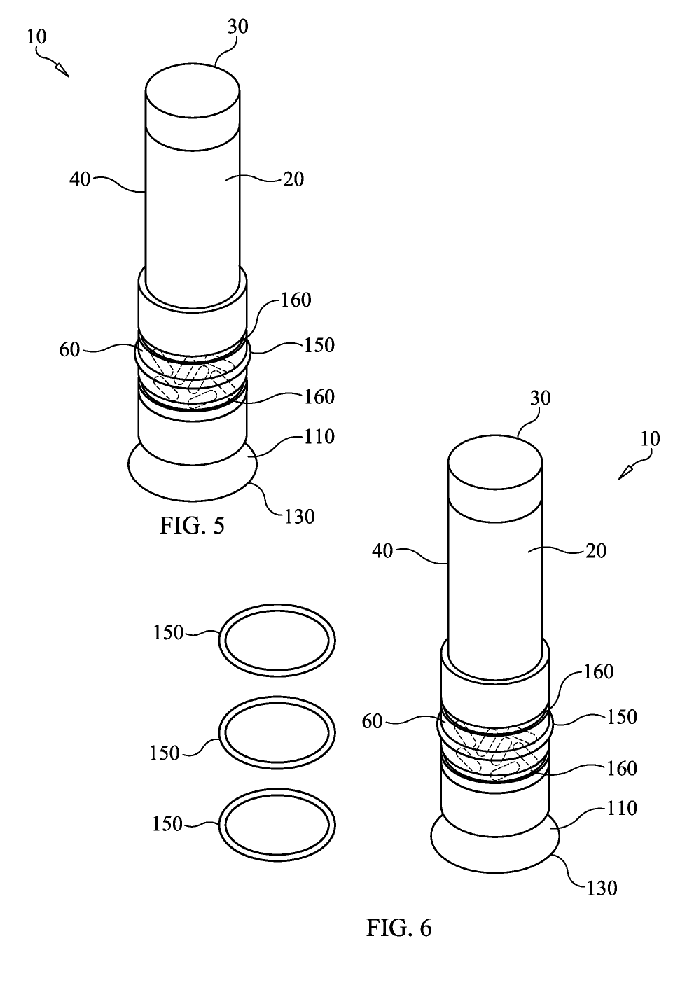

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

In various embodiments, the present invention is a drug delivery apparatus 10. The apparatus 10 includes a lower vessel 20 having a bottom wall 30 and sidewall structure 40 extending from the bottom wall 30. The lower vessel 20 may be a conventional medicine bottle. The lower vessel 20 includes a first connection component 50 disposed at a top region of the sidewall structure 40.

In various embodiments, the apparatus further includes an upper vessel 60. The upper vessel 60 includes a second connection component 70 adapted to interface with the first connection component 50. The upper vessel 60 further includes a separating wall 80 at a lower portion of the upper vessel 60, an upper sidewall structure 90, and a third connection component 100. Thus, the upper vessel 60 is adapted to attach to an upper portion of the lower vessel 20 to form two separated compartments of the apparatus 10 in a first mode.

A cap 110 is provided. The cap 110 attaches to the upper vessel 60 via a fourth connection component 120 adapted to interface with the third connection component. The first, second, third, and fourth connection components, 50, 70, 100, and 120, may be any suitable connection components, however, ideally, they are threading portions enabling the parts to be connected by screwing them together.

In various embodiments, the upper vessel 60 is adapted to contain a first portion of medication, and the lower vessel 20 is adapted to contain a second portion of such medication greater than the first portion. For example, one week's worth of medication may be stored in the upper vessel 60, and the remainder of the medication in the lower vessel 20.

In certain embodiments, the third connection component 100 is adapted to interface with the first connection component 70. Thus, the upper vessel 60 is adapted to be connected to the lower vessel by turning it upside down and interfacing the first connection component 70 with the third connection component 100, thus forming a large joint compartment in a second mode. Ideally, the apparatus 10 is turned upside down in a third mode, such that the upper vessel 60 is below the lower vessel 20.

In various embodiments, the cap 110 has an extended outer perimeter 130 adapted to serve as a base of support when the apparatus 10 is turned upside down in a third mode. Optionally, the cap 110 may include a concave, cup-shaped indentation 140 on a top side adapted to hold dispensed medication.

In certain embodiments, the apparatus 10 further includes a medication level indicator 150 disposed on an outer side of the apparatus 10. Ideally, the level indicator 150 is movable between a plurality of levels to enable the indicator to indicate when a predetermined amount of medication remains, such as one week's worth of medication. For example, optional grooves 160 may provide different levels for indicator 150.

Optional level indicator 150 can be any suitable marker, such as a band or ring surrounding the apparatus 10, or a sticker, or permanent or removable indicator of any desired type. Multiple level indicators 150 may be provided and may include color coding so that medicines or intended patients such as different family members may be differentiated.

It is understood that the upper vessel 60 may be adapted to fit conventional medicine bottles, and thus, may be applied to an existing bottle as an after market addition, for example, through use of the existing threading on existing bottles. Alternatively, upper vessel 60 and lower vessel 20 may be manufactured to interface with one another. Multiple size upper vessels 60 may be provided in order to fit different sized medicine bottles. In certain embodiments, a one size fits all upper vessel 60 may be provided using a connection mechanism that attaches to a plurality of different sized medicine bottles Like existing medicine bottles, the upper vessel 60 is optionally tinted to prevent damage to medication due to light.

In various embodiments, the present invention also encompasses a method for providing a drug dispenser. The method includes the steps of providing an upper vessel 60 having a lower separating wall 80, connecting the upper vessel 60 at a first end to a medicine bottle, and providing a cap 110 and connecting the cap 110 to a top portion of the upper vessel 60, thus forming two separate compartments in a first mode.

In various embodiments, the method further includes the steps of enabling the upper vessel 60 to be connected to the medicine bottle at a second end, wherein a joint compartment is provided in a second mode.

In certain embodiments, the method additionally includes placing a first quantity of a medication in a first compartment in the medicine bottle, and placing a second quantity of such a medication in a second compartment of the upper vessel 60 separated from the first compartment. Thus, a preselected amount of medication may be kept in the upper vessel 60, such as one week's worth of medication. Once no medication remains in the lower vessel 20, the patient may know that it is time to refill or reorder medication.

The method may also include the step of providing a level indicator 150 on the upper vessel 60 adapted to indicate a specified quantity of such a medicine remaining in the joint compartment in a third mode in which the drug dispenser 10 is positioned upside down.

While specific embodiments have been illustrated and described, numerous modifications come to mind without significantly departing from the spirit of the invention and the scope of protection is limited by the scope of the accompanying claims.

What is claimed is:

1. A drug delivery apparatus comprising:
a lower vessel having a bottom wall and sidewall structure extending from said bottom wall, and a first connection component disposed at a top region of said sidewall structure,
an upper vessel having a second connection component adapted to interface with said first connection component, a separating wall at a lower portion of said upper vessel, an upper sidewall structure, and a third connection component, wherein said upper vessel is adapted to attach to an upper portion of said lower vessel to form two separated compartments of said apparatus in a first mode,
a cap having a fourth connection component adapted to interface with said third connection component.

2. The drug delivery apparatus according to claim 1, wherein said apparatus is a medicine container.

3. The drug delivery apparatus according to claim 2, wherein said upper vessel is adapted to contain a first portion of medication, and wherein said lower vessel is adapted to contain a second portion of such medication greater than said first portion.

4. The drug delivery apparatus according to claim 3, wherein said third connection component is adapted to interface with said first connection component, and wherein said upper vessel is adapted to be connected to said lower vessel by interfacing said first connection component with said third connection component forming a large joint compartment in a second mode.

5. The drug delivery apparatus according to claim 4, wherein said cap has an extended outer perimeter adapted to serve as a base of support when said apparatus is turned upside down in a third mode.

6. The drug delivery apparatus according to claim 5, wherein said cap further comprises a cup-shaped concave indentation on a top side adapted to hold dispensed medication.

7. The drug delivery system according to claim 4, further comprising a medication level indicator disposed on an outer side of said apparatus.

8. The drug delivery system according to claim 7, wherein said medication level indicator is movable between a plurality of levels.

9. A drug delivery apparatus comprising:
an upper vessel adapted to attach to a medicine bottle having a second connection component adapted to interface with a first connection component on such a medicine bottle, a separating wall at a lower portion of said upper vessel, an upper sidewall structure, and a third connection component, wherein said upper vessel is adapted to attach to an upper portion of such a medicine bottle to form two separated compartments when attached to such a medicine bottle in a first mode,
a cap having a fourth connection component adapted to interface with said third connection component.

10. The drug delivery apparatus according to claim 9, wherein said upper vessel is adapted to contain a first portion of medication smaller than a portion of medication contained in such a medicine bottle.

11. The drug delivery apparatus according to claim 10, wherein said third connection component is adapted to interface with such a first connection component, and wherein said upper vessel is adapted to be connected to such a medicine bottle by interfacing such a first connection component with said third connection component forming a large joint compartment in a second mode.

12. The drug delivery apparatus according to claim 11, wherein said cap has an extended outer perimeter adapted to serve as a base of support when said apparatus is turned upside down in a third mode.

13. The drug delivery apparatus according to claim 12, wherein said cap further comprises a cup-shaped concave indentation on a top side adapted to hold dispensed medication.

14. The drug delivery system according to claim 11, further comprising a medication level indicator disposed on an outer side of said apparatus.

15. The drug delivery system according to claim 14, wherein said medication level indicator is movable between a plurality of levels.

16. The drug delivery system according to claim 9, wherein said third and fourth connection components comprise threading.

17. A method for providing a drug dispenser comprising the steps of:
providing an upper vessel having a lower separating wall,
connecting said upper vessel at a first end to a medicine bottle,
providing a cap and connecting said cap to a top portion of said upper vessel, wherein two separate compartments are created in a first mode.

18. The method according to claim 17, further comprising the steps of:
enabling said upper vessel to be connected to said medicine bottle at a second end, wherein a joint compartment is provided in a second mode.

19. The method according to claim 17, further comprising the steps of:
placing a first quantity of a medication in a first compartment in said medicine bottle, and
placing a second quantity of such a medication in a second compartment of said upper vessel separated from said first compartment.

20. The method according to claim 18, further comprising the step of:
providing a level indicator on said upper vessel adapted to indicate a specified quantity of such a medicine remaining in said joint compartment in a third mode in which said drug dispenser is positioned upside down.
